(19) United States
(12) Patent Application Publication
(10) Pub. No.: US 2016/0314209 A1
(43) Pub. Date: Oct. 27, 2016

(54) CONTENT DISTRIBUTION BASED ON ENTITY IDENTIFIERS

(71) Applicant: LinkedIn Corporation, Mountain View, CA (US)

(72) Inventors: AVIAD PINKOVEZKY, Los Altos, CA (US); JAMES MARGATAN, San Jose, CA (US); MICHAEL BRENTLEY DIMAPILIS, Sunnyvale, CA (US); HUINING FENG, Cupertino, CA (US)

(21) Appl. No.: 14/693,145

(22) Filed: Apr. 22, 2015

(51) Int. Cl. G06F 17/30; H04L 29/08

(52) U.S. Cl. CPC G06F 17/30867; H04L 67/306; G06F 17/30876

(57) ABSTRACT

Techniques are provided for a particular party to distribute content provided by other parties. The particular party receives multiple textual content items from a data source provided by a different party. Furthermore, the particular party determines, for each textual content item, whether the textual content item is associated with metadata that includes an instance of an entity identifier in a set of entity identifiers maintained by the particular party. The instance is provided by the different party. Each entity identifier in the set of entity identifiers uniquely identifies a different respective entity of a plurality of entities and indicates whether the different respective entity is a subject of the textual content item. In response to determining that a textual content item is associated with metadata that includes an instance of an entity identifier in the set of entity identifiers, target users are determined based on the entity identifier.

### FIELD OF THE DISCLOSURE

Embodiments relate to content identification and, more specifically, to content distribution based on entity identifiers.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A user, such as an investor, an executive, or a competitor, may wish to receive information concerning an entity, such as a person, a company, or an educational institution. For example, the user may subscribe to print and/or electronic media that keep the user abreast of current events. However, the user may sift through a tremendous amount of content yet find nothing relevant to the entity. As a result, the user may become frustrated by the waste of time and/or money and stop trying to remain current regarding the entity. Worse yet, the user may suffer from an uninformed decision, because certain information about the entity remained unknown to the user.

### BRIEF DESCRIPTION OF THE DRAWINGS

In the drawings:

FIG. 1 is a flow diagram that depicts an approach for content distribution based on entity identifiers.

FIG. 2 depicts an approach for associating textual content items with entities.

FIG. 3 depicts an approach for distributing textual content items to target users.

FIG. 4 is a table that depicts an approach for inferring user interest in textual content items.

FIG. 5 depicts a computer system upon which an embodiment may be implemented.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first”, “second”, and “third” may be used to differentiate elements, but the modifiers do not necessarily indicate any particular order. For example, a first party may be so named although, in reality, it may be a second, third, and/or fourth party.

### General Overview

A system and method of content distribution based on entity identifiers are disclosed. In an embodiment, a content distributor may obtain a media publication from a content provider that is different from the content distributor. The content provider may cause tagging the media publication with an entity identifier that indicates whether a particular entity is a topic of the media publication. Based on the entity identifier that indicates that the particular entity is the topic of the media publication, a target user is determined. The target user may be interested in the media publication and/or the particular entity. The target user may be sent a link to the media publication or a recommendation to consume the media publication.

### Process Overview

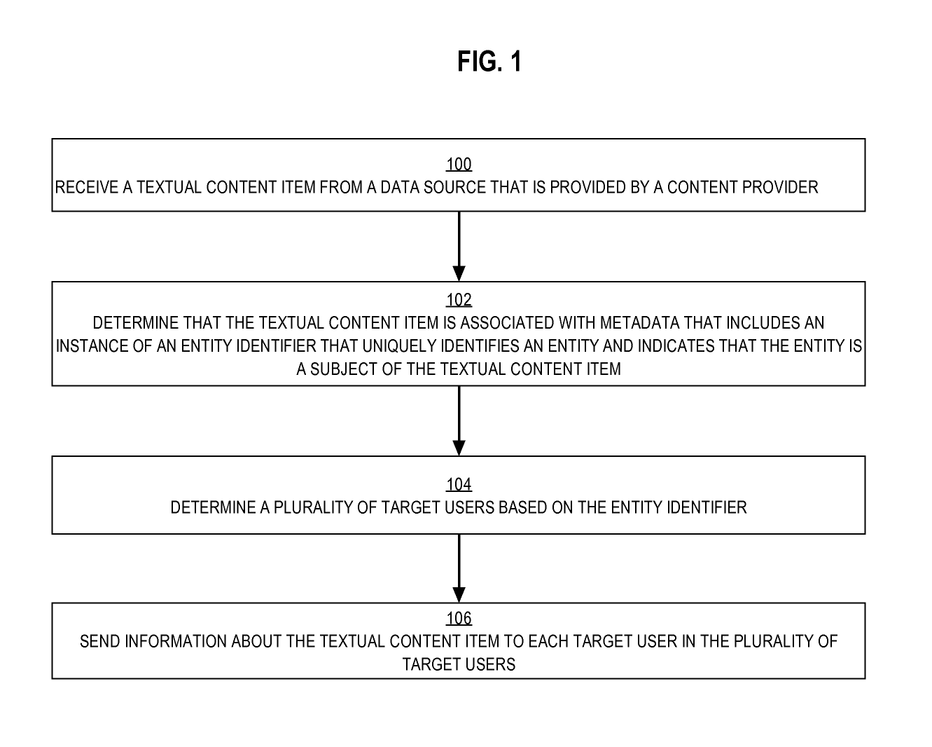

FIG. 1 is a flow diagram that depicts an approach for content distribution based on entity identifiers. The approach of FIG. 1 may be performed by a content distributor that is different than the parties that author the content. The content distributor may be a primary publisher, a secondary publisher, a content recommender, a search engine provider, a social network provider (e.g., LinkedIn, Google+, or Facebook), a blog host, a web feed subscriber, and/or a web feed provider.

At block 100, a textual content item is received from a data source that is provided by a content provider that is different from the content distributor. The textual content item may be one of many textual content items that are received from the data source. For example, the textual content item may be a news article, an advertisement, a blog post, and/or a social media publication.

The content provider may provide the data source by hosting the data source, contributing to the data source, sponsoring the data source, and/or otherwise making the data source available for consumption. Examples of content providers include a primary publisher, a secondary publisher, an author, a blogger, a member of a social media network, an entity, and/or a sponsor of a media publication. For example, a content distributor may receive a news article from a website of a newspaper publisher. In another example, the content distributor may receive a blog post of a blogger who contributes to a blog forum. In yet another example, the content distributor may receive an advertisement that is shared between users via a web feed. In still another example, the content distributor may receive a document from a set of documents that are sponsored by a corporation.

At block 102, the textual content item is determined to be associated with metadata that includes an instance of an entity identifier in a set of entity identifiers maintained by the content distributor. Each entity identifier in the set of entity identifiers uniquely identifies a different respective entity of a plurality of entities without simply referring to a name of the different respective entity. For example, entities include a person, a company, an organization, and an educational institution. Examples of entity identifiers include initials, alphanumeric strings, hash values, and/or stock ticker symbols. Entity identifiers may be locally and/or globally unique. For example, stock ticker symbols may be unique to a particular stock exchange, but hash values may be globally unique.

The content provider provides the instance of the entity identifier by causing the instance of the entity identifier to be included in the metadata associated with the textual content item. The content provider may provide the instance of the entity identifier in a number of ways. For example, the content provider associates the entity identifier with the textual content item when the content provider (a) stores the entity identifier with the textual content item, (b) confirms that an entity is a subject of the textual content item, and/or (c) otherwise indicates that the entity identifier is related to the textual content item.

For example, the content provider may be a web publisher that, prior to publishing a news article, embeds in the news article a stock exchange symbol for each company that is discussed in the news article. In another example, the content provider may be a blogger who, after writing a blog post about a non-profit organization, is prompted to confirm that the blog post is about the non-profit organization by a blog host that scans the blog post for text identifying the non-profit organization. In yet another example, the content provider may be a social media network user who indicates that a celebrity is mentioned at a particular uniform resource locator (URL) when the social media network user shares the particular URL with another user. In still another example, the content provider may be a private school that indicates that an advertisement is related to the private school when the private school sponsors the distribution of the advertisement.

The content distributor maintains a mapping between entity identifiers and entities. Based on the mapping, the content distributor may determine whether an entity is a subject of the textual content item. For example, when the metadata associated with the textual content item includes a particular entity identifier, the particular entity identifier indicates that the textual content item mentions the entity that corresponds to the particular entity identifier.

At block 104, a plurality of target users is determined based on the entity identifier. The entity identifier may correspond to a particular entity in which the plurality of target users may have an interest. The interest may be determined based on user behavior information and/or user profile information. For example, a target user may (a) have subscribed to updates about the particular entity, (b) have previously consumed content related to the particular entity, and/or (c) share one or more similarities with a user who is interested in the particular entity.

At block 106, information about the textual content item is sent to each target user in the plurality of target users. The information may comprise a hyperlink to the textual content item, a suggestion to subscribe to updates about the particular entity, a preview of the textual content item, and/or any other direct or indirect reference to the textual content item. For example, the particular entity may be recommended to a particular target user by automatically completing a search query initiated by the particular target user. The search query may be automatically completed based on entity rankings corresponding to interest levels of the particular target user. Results of the search query may include the textual content item. The approach may repeat as necessary.

### Providing an Instance of an Entity Identifier

Various actions, alone or in any combination, of the content provider may cause generation of the instance of the entity identifier. For example, the content provider may comprise a primary publisher, a secondary publisher, an author, and/or a sponsor.

As a primary publisher, the content provider may publish the textual content item with the instance of the entity identifier. For example, prior to publishing the textual content item, the content provider may internally (e.g., in a same file and/or structure as the textual content item) and/or externally (e.g., in a separate file and/or field from the textual content item) store, as metadata, the instance of the entity identifier with the textual content item.

As an author, the content provider may submit the textual content item for publication and be prompted to confirm that the textual content item is related to a particular entity. The textual content item may have been previously scanned for text that is related to the particular entity. When the content provider confirms that the textual content item is related to the particular entity, an instance of an entity identifier that corresponds to the particular entity may be generated and/or stored with the textual content item.

For example, when a blogger submits a blog post, the blogger may receive an alert message that requests a confirmation that a particular entity is a topic of the blog post. The alert message may include names of multiple possible entities. A string search algorithm may have been performed on the blog post to identify a reference to the particular entity in the blog post. When the blogger submits the confirmation, metadata identifying the particular entity may be generated and/or stored with the blog post.

As a secondary publisher, the content provider may indicate that the textual content item is related to a particular entity when the content provider shares the textual content item with another party. For example, the content provider may send, to a friend, a message that references (e.g., by a URL) a news article. The content provider may include, in the message, an indication that the news article is related to a particular entity. As a result, an instance of an entity identifier that corresponds to the particular entity may be generated and/or stored with the news article.

As a sponsor, the content provider may compensate the content distributor for publishing and/or distributing the textual content item. For example, the content provider may find a particular editorial flattering and may pay a web publisher to place the particular editorial on one or more web pages. Sponsoring the editorial may indicate that the editorial is related to the content provider, and metadata identifying the content provider may be generated and/or stored with the editorial.

When the instance of the entity identifier is generated, the textual content item may be provided via a data source. The data source may be a web site, a blog forum, a web feed, and/or any other collection of textual content items and/or references to textual content items. For example, the textual content item may be provided to the content distributor via a web page, such as “www.mercurynews.com”.

### Associating Textual Content Items with Entities

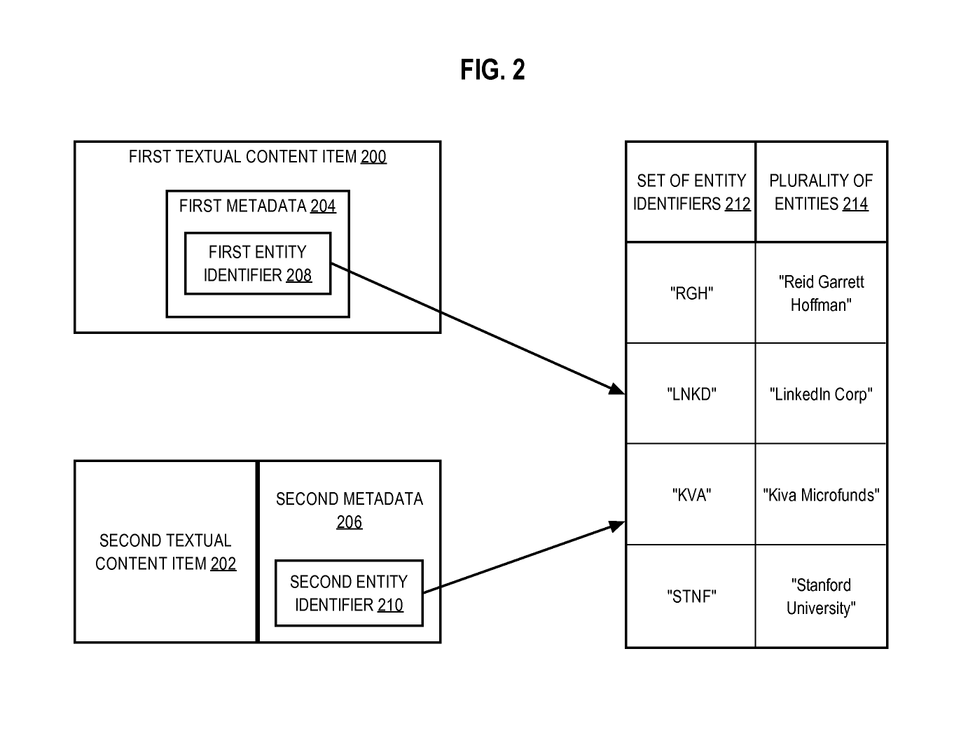

FIG. 2 depicts an approach for associating textual content items with entities. In the example of FIG. 2, first textual content item 200 is associated with first metadata 204 comprising first entity identifier 208 that uniquely identifies an entity based on a mapping between set of entity identifiers 212 and plurality of entities 214. Additionally, second textual content item 202 is associated with second metadata 206 comprising second entity identifier 210 that uniquely identifies another entity based on the mapping in the example of FIG. 2.

Each of first textual content item 200 and second textual content item 202 may be a document, a web document, a news article, an editorial, a blog post, a web feed entry, a file, an advertisement, a coupon, a media publication, and/or any other content that is primarily consumed by reading. For example, first textual content item 200 or second textual content item 202 may be a document in a Portable Document Format (PDF) file format. First textual content item 200 or second textual content item 202 may be referenced by a URL.

Each of first metadata 204 and second metadata 206 may be information that describes an associated textual content item. For example, first metadata 204 or second metadata 206 may include an author, a genre, and/or a publication date. First metadata 204 and second metadata 206 are associated with first textual content item 200 and second textual content item 202, respectively.

First metadata 204 and second metadata 206 may be stored internally and/or externally with first textual content item 200 and second textual content item 202, respectively. In the example of FIG. 2, first metadata 204 is depicted as being stored internally with first textual content item 200, and second metadata 206 is depicted as being stored externally with second textual content item 202.

Each of first entity identifier 208 and second entity identifier 210 may uniquely identify a particular entity in plurality of entities 214. Each of first entity identifier 208 and second entity identifier 210 may be a locally and/or globally unique alphanumeric code, such as a stock symbol or a hash value. For example, first entity identifier 208 and second entity identifier 210 may be locally unique to a first content provider and a second content provider, respectively. However, the content distributor may translate first entity identifier 208 or second entity identifier 210 into a hash value that corresponds to a particular entity.

In the example of FIG. 2, first entity identifier 208 is “LNKD” and differs from second entity identifier 210, which is “KVA”. Thus, first textual content item 200 and second textual content item 200 may be different textual content items that discuss different topics. However, in an embodiment, a single textual content item may have be associated with more than one entity identifier. For example, the single textual content item may be associated with both first entity identifier 208 and second entity identifier 210, thereby indicating that the single textual content item mentions both “LinkedIn Corp” and “Kiva Microfunds”.

In an embodiment, first entity identifier 208 and second entity identifier 210 may both identify a same entity. For example, first entity identifier 208 and second entity identifier 210 may be “LNKD” and “L5&1n”, respectively, but both first entity identifier 208 and second entity identifier 210 may identify “LinkedIn Corp”. In an embodiment, first entity identifier 208 and second entity identifier 210 may be a same entity identifier, indicating that first and second textual content items contain a reference to the same entity. For example, first entity identifier 208 and second entity identifier 210 may both be “LNKD”.

The content distributor may extract first entity identifier 208 and second entity identifier 210 from first metadata 204 and second metadata 206, respectively. For example, the content distributor may search for first entity identifier 208 or second entity identifier 210 in a predetermined field, such as a HyperText Markup Language (HTML) element of the form “<meta name=‘entity’ http-equiv=‘entity’ content=‘LNKD’/>”.

Set of entity identifiers 212 comprises first entity identifier 208 and second entity identifier 210 and may be maintained by the content distributor. For example, the content distributor may maintain a data store containing set of entity identifiers 212. In an embodiment, the content distributor may also maintain a mapping between set of entity identifiers 212 and a set of internal identifiers used by the content distributor. For example, the set of internal identifiers may comprise a set of hash values that provide globally unique identifiers for plurality of entities 214.

Each entity of plurality of entities 214 may correspond to a person, a company, an organization, an educational institution, and/or anything else of interest to consumers. For example, each entity of plurality of entities 214 may correspond to a celebrity, a public figure, a corporation, a non-profit organization, a social club, a group of political activists, and/or a university. The content distributor may maintain a mapping between plurality of entities 214 and set of entity identifiers 212 and/or the set of internal identifiers.

When a particular textual content item is determined to have an association with a particular entity based on set of entity identifiers 212, the content distributor may maintain the association in a data store. For example, the content distributor may maintain a repository that stores a mapping between a particular URL and a particular entity.

### Distributing Textual Content Items to Target Users

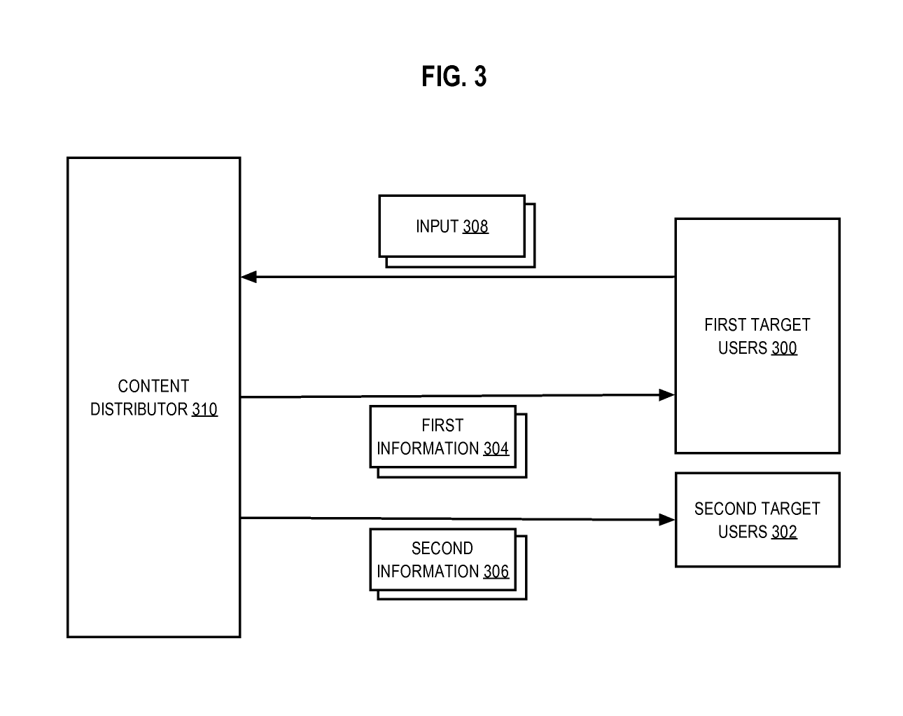

FIG. 3 depicts an approach for distributing textual content items to target users. In the example of FIG. 3, content distributor 310 receives input 308 from first target users 300 and sends first information 304 to first target users 300. Additionally, content distributor 310 sends second information 306 to second target users 302.

First target users 300 and second target users 302 comprise users who may have an interest in first textual content item 200 and second textual content item 202, respectively. The interest in first textual content item 200 and/or second textual content item 202 may be explicitly communicated to content distributor 310. Additionally or alternatively, the interest in first textual content item 200 and/or second textual content item 202 may be inferred based on user behavior information and/or user profile information.

First information 304 and second information 306 may comprise references to first textual content item 200 and second textual content item 202, respectively. For example, first information 304 may be a web feed entry comprising a URL that references first textual content item 200. Sending first information 304 and/or second information 306 may be regulated based on a priority level of a textual content item and/or a consumption level of a target user. For example, first information 304 and/or second information 306 may be sent immediately when a textual content item is a breaking news story. In another example, a frequency with which first information 304 and/or second information 306 is sent to a particular target user may be decreased when textual content items remain largely unconsumed by the particular target user. The consumption level of the particular target user may be determined based on tracking cookies and/or client-side scripts, for example.

In another example, first information 304 may be a recommendation to consume first textual content item 200. The recommendation may involve a preview of first textual content item 200, a suggestion to subscribe to updates about an entity mentioned in first textual content item 200, and/or a suggestion to complete a search query with the entity mentioned in first textual content item 200. For example, a relevancy score may be determined for each entity of plurality of entities 214 based on a number of content items that mentions an entity within a predetermined time period and/or a number of users who subscribed to updates about the entity.

Additionally or alternatively, a user-specific relevancy score may be determined based on one or more similarities with users who consumed content about the entity and/or a particular textual content item about the entity. Based on the relevancy score and/or the user-specific relevancy score, content may be recommended to a target user. For example, input 308 may be received from a single user in first target users 300. The other users in first target users 300 are identified as being similar to the single user. Thus, the content distributor not only provides first information 304 to the single user, but also to the other users in first target users 300.

Input 308 may be an indication that a target user desires to receive content about a particular entity. For example, content distributor 310 may receive input 308 when a target user subscribes to a web feed about a particular entity.

### Inferring User Interest in Textual Content Items

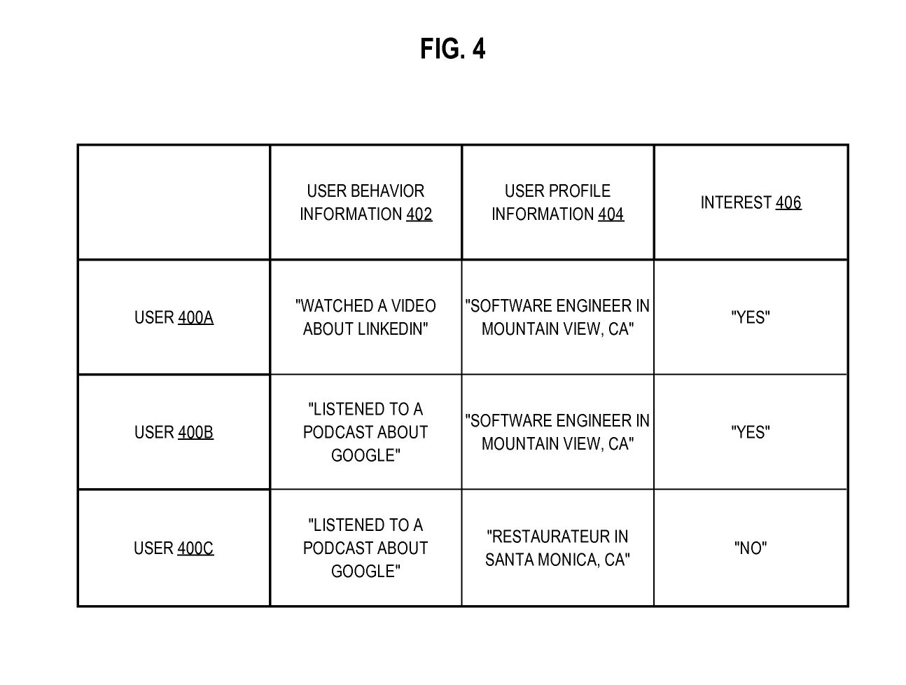

FIG. 4 is a table that depicts an approach for inferring user interest in textual content items. In the example of FIG. 4, interest 406 of a user 400A, 400B, 400C is determined based on user behavior information 402 and/or user profile information 404.

User 400A, 400B, 400C may be registered with content distributor 310. Content distributor 310 may determine whether to include user 400A, 400B, 400C in a plurality of target users who are interested in a particular textual content item associated with a particular entity identifier. Based on the particular entity identifier, content distributor 310 may determine that the particular textual content item is related to a particular entity. Based on interest 406 in the particular entity, content distributor 310 may then determine the plurality of target users.

User behavior information 402 may be monitored based on tracking cookies and/or client-side scripts, for example. User behavior information 402 may comprise an interaction with content. For example, interest 406 in a particular textual content item may be inferred based on an amount of prior interaction with content related to a particular entity mentioned in the particular textual content item. In another example, interest 406 in the particular textual content item may be inferred based on an amount of prior interaction with content related to an entity that is similar to the particular entity. A similarity may be based on a similar physical appearance between entities, a similar industry of the entities, a similar demographic of users interested in the entities, etc. For example, prior interaction with content related to “Facebook” may suggest interest 406 in content related to “LinkedIn” based on an overlap between groups of members who follow the two companies.

User profile information 404 may comprise personal and/or professional attributes. The personal attributes of a user 400A, 400B, 400C may comprise age, educational background, hobbies, and/or identities of people that influence the user 400A, 400B, 400C. The professional attributes of a user 400A, 400B, 400C may comprise occupation, experience level, job skills, and/or employer size. For example, interest 406 in a particular textual content item may be inferred based on an industry shared with a particular entity mentioned in the particular textual content item.

In the example of FIG. 4, user 400A is determined to have interest 406 in a textual content item about “LinkedIn Corp” based on user behavior information 402 of having “watched a video about LinkedIn” and/or user profile information 404 of being a “software engineer in Mountain View, Calif.”. User 400B is also determined to have interest 406 in the textual content item about “LinkedIn Corp” based on user behavior information 402 that is shared with user 400A. However, user 400C is determined to have no interest 406 the textual content item about “LinkedIn Corp”, because neither user behavior information 402 nor user profile information 404 suggests interest 406. Furthermore, user 400C does not share user profile information 404 with either user 400A or user 400B.

### Recommending Content Related to Entities

Content may be distributed by recommending the content and/or an entity related to the content. Entities may be determined to be related to content with or without a content provider providing entity identifiers. For example, a heuristic algorithm may be used to correlate a particular entity with a particular content item.

In an embodiment, content distributor 310 may recommend an entity to a user based on an entity ranking. Entity rankings may be determined for a set of users, such as a single user, a group of similar users, and/or all users. Entity rankings may differ for different sets of users. Entity rankings may be determined based on relevancy scores for each entity of plurality of entities 214. Entity rankings may be determined for a particular type of entity, such as a person, a company, organization, and educational institution.

When an entity ranking is determined for all users, the entity ranking may be based on a number of content items that mentions a particular entity within a predetermined time period. For example, in the last two days, LinkedIn, Google, Facebook, and Twitter may have been mentioned in two, eighteen, nineteen, and eleven news articles, respectively. Thus, the entity ranking, in order of relevance, may be Facebook, Google, Twitter, and LinkedIn. Content distributor 310 may present a user with a list of entities in which the user may have an interest. Facebook may top the list and be followed by Google, Twitter, and LinkedIn, according to the entity ranking.

Entity rankings may be determined based on user-specific relevancy scores. For example, when an entity ranking is determined for a single user, the entity ranking may be based on the interests of users who share one or more similarities with the single user. The entity ranking may account for differences between users based on a weighting system. For example, in the last two days, a first user group who works in the same industry as the single user may have consumed news articles at an average rate per user of one, three, four, and two for LinkedIn, Google, Facebook, and Twitter, respectively. In the last two days, a second user group who works in the same industry and at the same company as the single user may have consumed news articles at an average rate per user of two, four, three, and one for LinkedIn, Google, Facebook, and Twitter, respectively. By double weighting the average rates of the second user group before adding the average rates of the first user group, the user-specific relevancy scores may be five, eleven, ten, and four for LinkedIn, Google, Facebook, and Twitter, respectively. Thus, the entity ranking for the single user, in order of relevance, may be Google, Facebook, LinkedIn, and Twitter.

In an embodiment, based on the entity ranking, an entity may be recommended to the user through an autocomplete feature of a search field. For example, when the user types “L”, content distributor 310 may suggest a predetermined number of entities whose names begin with “L”. The predetermined number of entities may be presented in an order determined by the entity ranking.

In an embodiment, based on the entity ranking, content may be recommended to the user. For example, the list of entities in which the user may have an interest may be accompanied by a suggestion to subscribe to a respective web feed for each entity in the list of entities. The suggestion to subscribe to the respective web feed may be accompanied by a preview of content provided by the web feed.

In an embodiment, search results generated from a search initiated by a user are ranked based on entity rankings. For example, if a first search result mentions a first entity and a second search result mentions a second entity, then the entity rankings of the first and second entities are used to generating result rankings for the search results. If the second entity has a higher entity ranking than the first entity, then the second search result may be ranked higher and, thus, may appear before the first search result in the set of search results.

### Implementation Examples

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

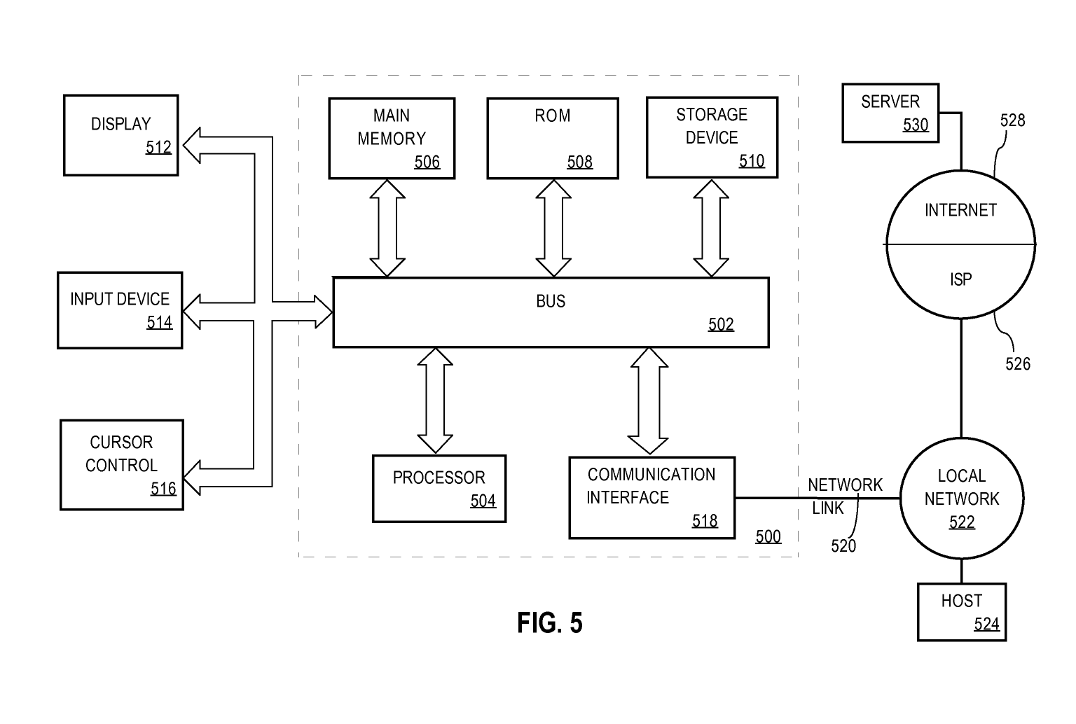

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method that is performed by a particular party comprising:
receiving a first plurality of textual content items from a first data source that is provided by a first party that is different than the particular party;
for each textual content item in the first plurality of textual content items, determining whether said each textual content item is associated with metadata that includes an instance of an entity identifier in a set of entity identifiers maintained by the particular party, wherein each entity identifier in the set of entity identifiers uniquely identifies a different respective entity of a plurality of entities, and wherein said each entity identifier indicates whether the different respective entity is a subject of said each textual content item;
in response to determining that a first textual content item of the first plurality of textual content items is associated with first metadata that includes an instance of a first entity identifier in the set of entity identifiers:
determining a first plurality of target users based on the first entity identifier,
sending first information about the first textual content item to each target user in the first plurality of target users,
wherein the instance of the first entity identifier was provided by the first party,
wherein the method is performed by one or more computing devices.

2. The method of claim 1, further comprising:
receiving a second plurality of textual content items from a second data source that is provided by a second party that is different than the particular party and the first party;
for each textual content item in the second plurality of textual content items, determining whether said each textual content item is associated with metadata that includes an instance of an entity identifier in the set of entity identifiers;
in response to determining that a second textual content item of the second plurality of textual content items is associated with second metadata that includes an instance of a second entity identifier in the set of entity identifiers:
determining a second plurality of target users based on the second entity identifier,
sending second information about the second textual content item to each target user in the second plurality of target users,
wherein the instance of the second entity identifier was provided by the second party.

3. The method of claim 2, wherein the second entity identifier is the same as the first entity identifier and uniquely identifies a particular entity.

4. The method of claim 1, wherein the first entity identifier uniquely identifies a company, a person, an organization, or an educational institution.

5. The method of claim 1, further comprising, prior to determining the first plurality of target users, receiving, from each target user of the first plurality of target users, input that indicates that said each target user desires to receive content about an entity associated with the first entity identifier.

6. The method of claim 1, further comprising, prior to sending the first information, inferring an interest in the first textual content item based on user profile information or user behavior information of each target user in the plurality of target users.

7. The method of claim 1, wherein the first party provides the first data source and the instance of the first entity identifier by publishing the first textual content item with the instance of the first entity identifier.

8. The method of claim 1, wherein the first party provides the first data source and the instance of the first entity identifier by authoring the first textual content item and confirming that the first textual content item is related to a particular entity in a manner such that the first party causes automatic generation of the instance of the first entity identifier.

9. The method of claim 1, wherein the first party provides the first data source and the instance of the first entity identifier by indicating, when sharing the first textual content item with another party, that the first textual content item is related to a particular entity in a manner such that the first party causes generation of the instance of the first entity identifier.

10. The method of claim 1, wherein the first party provides the first data source and the instance of the first entity identifier by sponsoring the first textual content item in a manner such that the first party causes generation of the instance of the first entity identifier.

11. A system comprising:
one or more processors; and
one or more non-transitory storage media storing instructions which, when executed by the one or more processors, cause a particular party to perform:
receiving a first plurality of textual content items from a first data source that is provided by a first party that is different than the particular party;
for each textual content item in the first plurality of textual content items, determining whether said each textual content item is associated with metadata that includes an instance of an entity identifier in a set of entity identifiers maintained by the particular party, wherein each entity identifier in the set of entity identifiers uniquely identifies a different respective entity of a plurality of entities, and wherein said each entity identifier indicates whether the different respective entity is a subject of said each textual content item;
in response to determining that a first textual content item of the first plurality of textual content items is associated with first metadata that includes an instance of a first entity identifier in the set of entity identifiers:
determining a first plurality of target users based on the first entity identifier,
sending first information about the first textual content item to each target user in the first plurality of target users,
wherein the instance of the first entity identifier was provided by the first party.

12. The system of claim 11, further comprising instructions which, when executed by the one or more processors, cause:
receiving a second plurality of textual content items from a second data source that is provided by a second party that is different than the particular party and the first party;
for each textual content item in the second plurality of textual content items, determining whether said each textual content item is associated with metadata that includes an instance of an entity identifier in the set of entity identifiers;
in response to determining that a second textual content item of the second plurality of textual content items is associated with second metadata that includes an instance of a second entity identifier in the set of entity identifiers:
determining a second plurality of target users based on the second entity identifier,
sending second information about the second textual content item to each target user in the second plurality of target users,
wherein the instance of the second entity identifier was provided by the second party.

13. The system of claim 12, wherein the second entity identifier is the same as the first entity identifier and uniquely identifies a particular entity.

14. The system of claim 11, wherein the first entity identifier uniquely identifies a company, a person, an organization, or an educational institution.

15. The system of claim 11, further comprising instructions which, when executed by the one or more processors, cause, prior to determining the first plurality of target users, receiving, from each target user of the first plurality of target users, input that indicates that said each target user desires to receive content about an entity associated with the first entity identifier.

16. The system of claim 11, further comprising instructions which, when executed by the one or more processors, cause, prior to sending the first information, inferring an interest in the first textual content item based on user profile information or user behavior information of each target user in the plurality of target users.

17. The system of claim 11, wherein the first party provides the first data source and the instance of the first entity identifier by publishing the first textual content item with the instance of the first entity identifier.

18. The system of claim 11, wherein the first party provides the first data source and the instance of the first entity identifier by authoring the first textual content item and confirming that the first textual content item is related to a particular entity in a manner such that the first party causes automatic generation of the instance of the first entity identifier.

19. The system of claim 11, wherein the first party provides the first data source and the instance of the first entity identifier by indicating, when sharing the first textual content item with another party, that the first textual content item is related to a particular entity in a manner such that the first party causes generation of the instance of the first entity identifier.

20. The system of claim 11, wherein the first party provides the first data source and the instance of the first entity identifier by sponsoring the first textual content item in a manner such that the first party causes generation of the instance of the first entity identifier.
